(19) United States
(12) Patent Application Publication
(10) Pub. No.: US 2003/0213342 A1
(43) Pub. Date: Nov. 20, 2003

(54) RATCHET WRENCH

(76) Inventor: Arthur Wu, Taichung Hsien (TW)

Correspondence Address: BACON & THOMAS, PLLC, 625 SLATERS LANE, FOURTH FLOOR, ALEXANDRIA, VA, 22314

(21) Appl. No.: 10/175,405

(22) Filed: Jun. 20, 2002

(30) Foreign Application Priority Data
May 17, 2002 (TW) 91207076

(51) Int. Cl. B25B 13/46

(52) U.S. Cl. 81/60

(57) ABSTRACT

A ratchet wrench comprises a handle having a head portion at an end thereof. The head portion has a through hole and a chamber, wherein the chamber has a side thereof communicated with the through hole and has a sidewall at the other side thereof. An engaging member has a polygonal hole at central thereof and an annular teeth portion at exterior surface thereof. The engaging member is installed in the through hole of the handle for free rotating. A pawl has a teeth portion at a side thereof. The pawl is received in the chamber of the handle at a side thereof resting against the sidewall in the chamber and has the teeth portion thereof detachable meshed with the teeth portion of the engaging member, and a self-positioned elastic member is made from a flexible wire to form a spiral positioning portion and an elastic arm. The self-positioned elastic member is received in the chamber of the chamber of the handle at the side opposite from the pawl, whereby the positioning portion rests against both of the sidewall of the chamber and the engaging member and the elastic arm has the free end thereof resting against the pawl.

### FIELD OF THE INVENTION

The present invention relates generally to a hand tool, and more particularly to a ratchet wrench.

### BACKGROUND OF THE INVENTION

FIG. 1 shows a conventional ratchet wrench 60 having a handle 61, an engaging member 63, a pawl 64 and a spring 65. The handle 61 has a head portion 62 at an end thereof, a through hole 621 at the head portion 62 and a chamber 622 communicated with the through hole 621. The handle 61 further has a slot 623 on the sidewall of the chamber 622. The engaging member 63 has a polygonal hole 631 at central and an annular teeth portion 632 at exterior surface thereof. The engaging portion 63 is rotatable installed in the through hole 621 of the handle 61. The pawl 63 is received in the chamber 622 of the handle 61 having a rod 641 at a side thereof. The spring 65 has an end thereof received in the slot 623 on the sidewall of the chamber 622 and the other end thereof engaging to the rod 641 of the pawl 64.

FIG. 2 shows an improved ratchet wrench 70, which drills a hole 711 at lateral side of the head 71. A bolt 72 is screwed into the hole 711 to make the spring 73 having an end resting against on the bolt 72 the relative inventions are U.S. Pat. No. 6,334,373, U.S. Pat. No. 6,205,889 and U.S. Pat. No. 4,991,468.

Please refer to FIG. 3, a ratchet wrench 80 taught in U.S. Pat. No. 5,636,557 discloses a stop piece 81 installed in the chamber 81. The fourth improved ratchet wrench 90 shown in FIG. 4 provides a metal block 92 in the chamber 92 for the spring 93 resting against thereon.

### SUMMARY OF THE INVENTION

The primary objective of the invention is to provide a ratchet wrench, which has an easy way to install the spring.

According to the objectives of the invention, a ratchet wrench comprises a handle having a head portion at an end thereof and a through hole and a chamber at the head portion, wherein the chamber is communicated with the through hole at a side thereof and has a sidewall at the other side thereof. An engaging member has a polygonal hole at central thereof and an annular teeth portion at exterior surface thereof. The engaging member is rotatable installed in the through hole of the handle. A pawl has a teeth portion at a side thereof. The pawl is received in the chamber of the handle at a side thereof and rests against the sidewall in the chamber. The pawl has the teeth portion thereof detachable meshed with the teeth portion of the engaging member, and a self-positioned elastic member has a positioning portion and an elastic arm as a unity. The self-positioned elastic member is received in the chamber of the chamber of the handle at the side opposite from the pawl, whereby the positioning portion rests against both of the sidewall of the chamber and the engaging member and the elastic arm has the free end thereof resting against the pawl.

### BRIEF DESCRIPTION OF THE DRAWINGS

FIG. 1 is a sectional view of a first conventional ratchet wrench;

FIG. 2 is a sectional view of a second conventional ratchet wrench;

FIG. 3 a sectional view of a third conventional ratchet wrench;

FIG. 4 is a sectional view of a fourth conventional ratchet wrench;

FIG. 5 is a sectional view of a first prefer embodiment of the present invention;

FIG. 6 is a sectional view along the 6-6 line in FIG. 5;

FIG. 7 is a perspective view of a self-positioned elastic member of the first prefer embodiment of the present invention;

FIG. 8 is a perspective view of the self-positioned elastic member engaging with a pawl;

FIG. 9 is a perspective view of an alternate self-positioned elastic member of the first prefer embodiment of the present invention;

FIG. 10 is a sectional view of the first prefer embodiment of the present invention, showing turning the handle reversibly;

FIG. 11 is a sectional view of a second prefer embodiment of the present invention;

FIG. 12 is a perspective view of a self-positioned elastic member of the second prefer embodiment of the present invention, and

FIG. 13 and FIG. 14 are perspective views of two alternate self-positioned elastic members of the second prefer embodiment of the present invention.

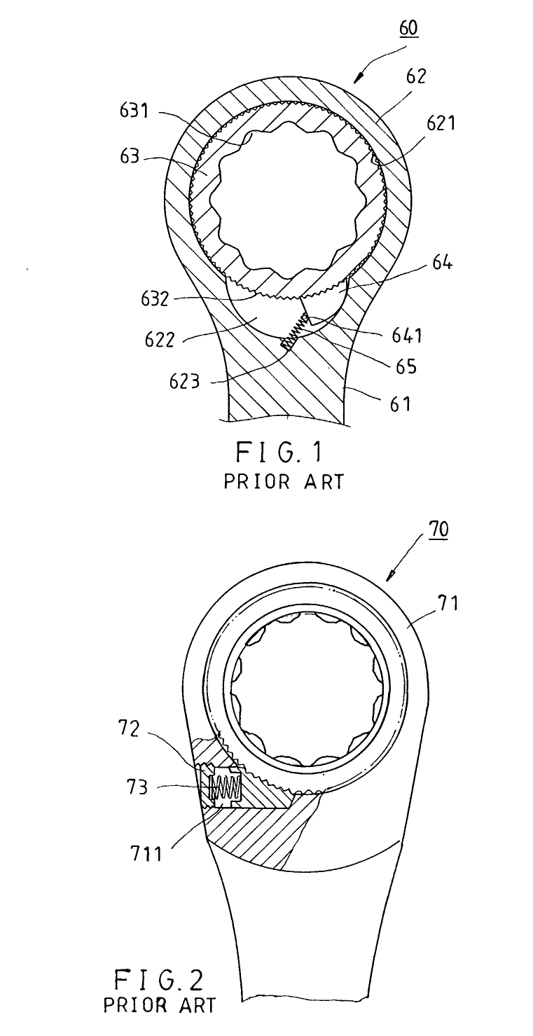

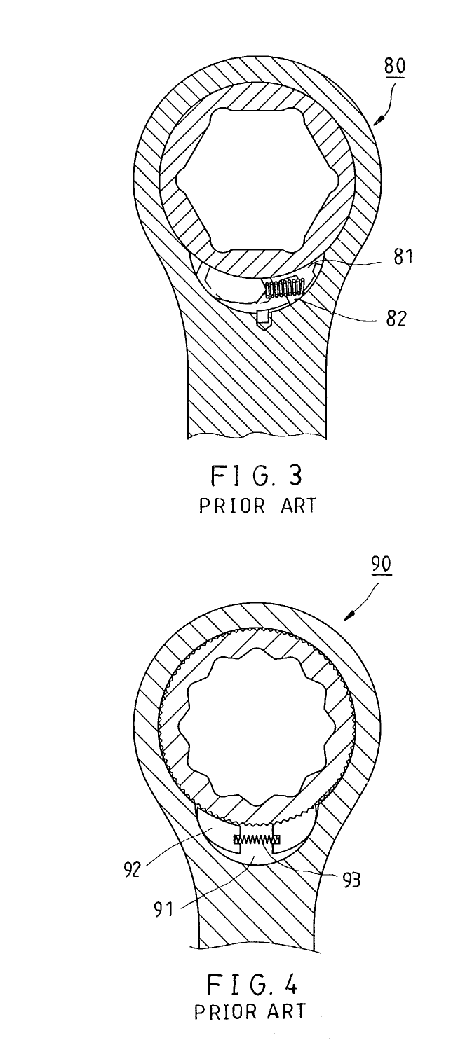

### DETAIL DESCRIPTION OF THE INVENTION

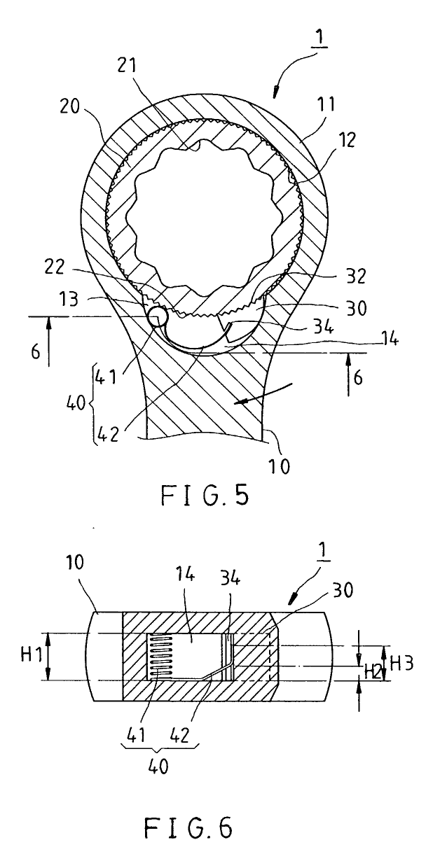

Please refer to FIG. 5 and FIG. 6, the prefer embodiment of the present invention provides a ratchet wrench 1 comprising:

A handle 10 has a head portion 11 at an end thereof where has a through hole 12 and a chamber 13. The chamber 13 is communicated with the through hole 12 at a side thereof and has a curved sidewall 14 at the other side thereof.

An engaging member 20 is an annular column in the present invention, which has a hexagonal hole or a dodecahedral hole 21 at central and an annular teeth portion 22 at exterior surface thereof. The engaging member 20 is rotatable installed in the through hole 12 of the handle 10. There are many prior arts taught how to install the engaging member 20 into the handle 10, so I will not disclose the detail here.

A pawl 30 has a teeth portion 32 and a slot 34. The pawl 30 is received in the chamber 13 of the handle 10 at a side thereof and rests against on the sidewall 14 of the chamber 13. The teeth portion 32 of the pawl 30 is meshed with the teeth portion 22 of the engaging member 20. A little movement of the pawl 30 will make it not meshed with the engaging member 20.

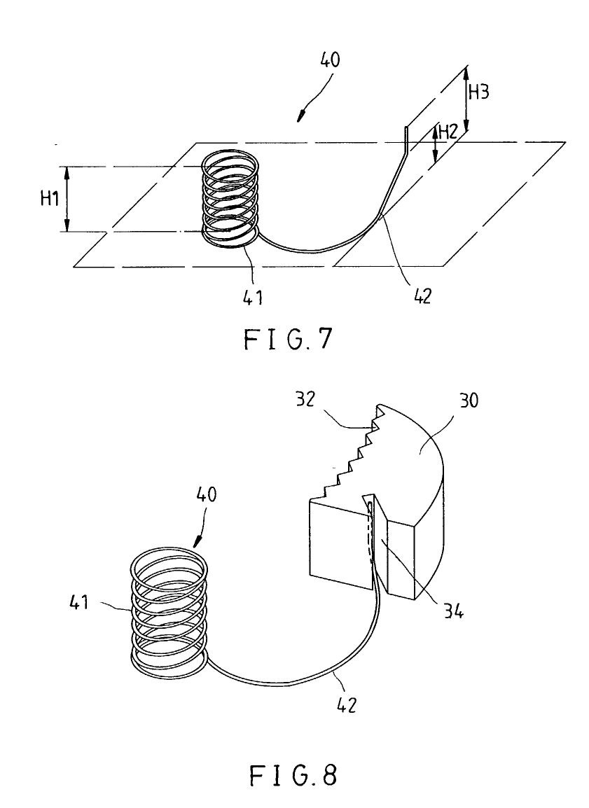

A self-positioned elastic member 40, referring to FIG. 7, is made from a metal wire to form a spiral positioning portion 41 and a elastic arm 42 projected from the positioning portion 41. You can refer to FIG. 6 and FIG. 7 to understand the detail structure of the self-positioned elastic member 40.

The self-positioned elastic member 40 is installed in the chamber 13 of the handle 10 at the side opposite from the pawl 30. The positioning portion 41 of the self-positioned elastic member 40 rests against both of the sidewall 14 of the chamber 13 and the teeth portion 22 of the engaging member 20 and the elastic arm 42 has the free end thereof suspended and is received in the slot 34 of the pawl 30 to provide the pawl 30 a spring force.

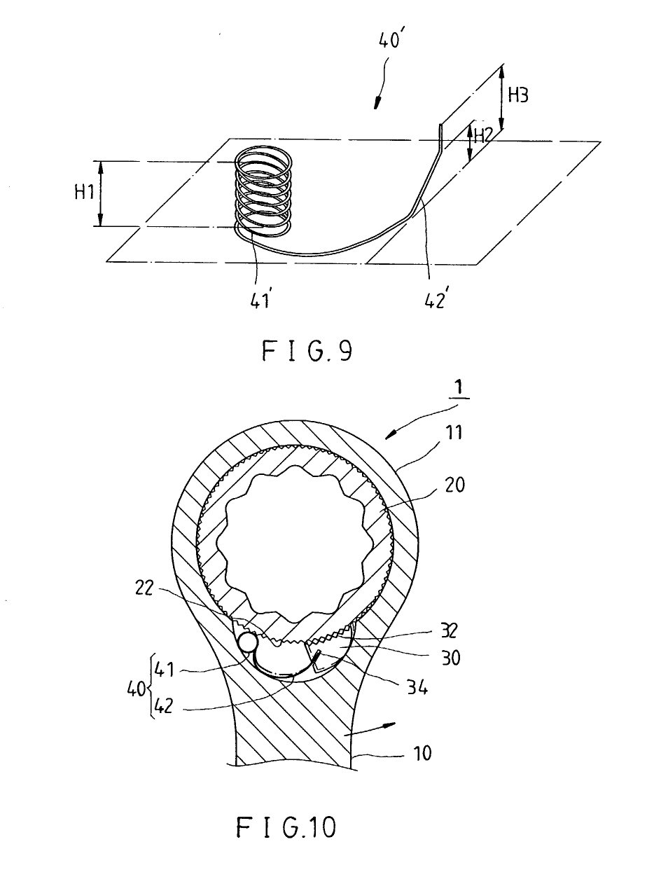

FIG. 9 shows an alternate self-positioned elastic member 40′, which has a positioning member 41′ and an elastic arm 42′. The self-positioned elastic member 40′ is similar to aforesaid self-positioned elastic member 40, except that the spiral orientation of the positioning member 41′ is opposite from the positioning member 41 of aforesaid self-positioned elastic member 40, but it has the same function as aforesaid self-positioned elastic member 40.

Please refer to FIG. 5 again, when turn the handle 10 clockwise, the teeth portion 32 of the pawl 30 will be meshed with the teeth portion 22 of the engaging member 20 to drive the engaging member 20 to turn with the handle 10 for turning tight or turning loose a bolt (or a nut). On the contrary, referring to FIG. 10, when turn the handle 10 counterclockwise, the pawl 30 will depart from the engaging member 20 to make the engaging member 20 keeping still.

It has to member here, please refer to FIG. 5, the included angle between the orientation of the slot 34 and the orientation of the diameter of the engaging member 20 is an acute angle. So, the elastic force F provided by elastic arm 42 to the pawl 30 can be divided into a tangent force Ft and a normal force Fn. The normal force Fn will make the pawl 30 having whole teeth portion 32 meshed with the teeth portion 22 of the engaging member 20. Thus, the ratchet wrench 1 of the present invention will have a larger power to turn the bolts or the nuts.

It is obvious to understand that the ratchet wrench 1 of the present invention has no extra element provided for installing the spring as the prior art did. The self-positioned elastic member 40 of the present invention has advantages of having a simple structure and easy to be installed in the ratchet wrench.

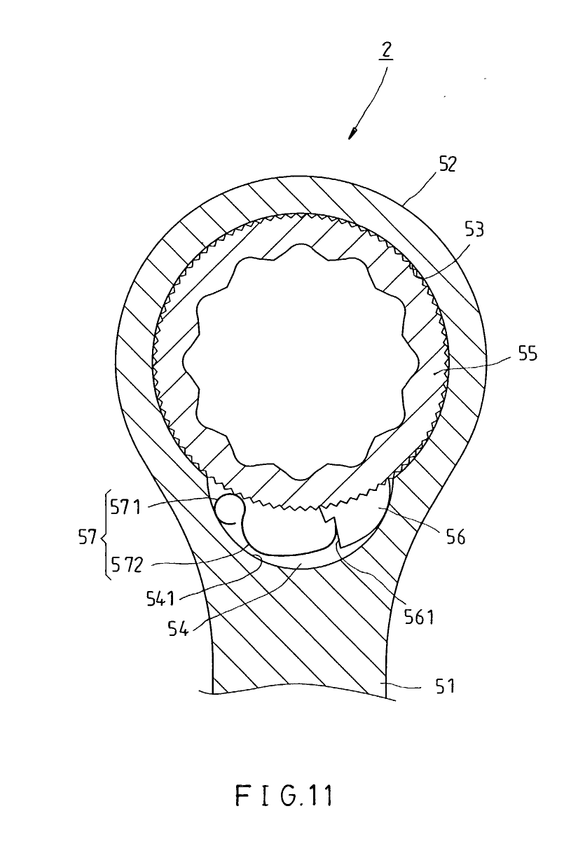

FIG. 11 shows a ratchet wrench 2 of the second prefer embodiment of the present invention, which has a handle 51, a head portion 52 at an end of the handle 51 where provides a through hole 53 and a chamber 54, a engaging member 55 rotatable installed in the through hole 53, a pawl 56 and a self-positioned elastic member 57 installed in the chamber 54. Please refer to FIG. 12, the self-positioned elastic member 57 of the second prefer embodiment is made from a flexible piece to form a positioning portion 571, which has a C-shape in cross-section, and a curved elastic arm 571. The pawl 56 is provided with a gap 561 thereon for the elastic arm 572 of the self-positioned elastic member 57 resting against thereon.

The operating mode and the functions of the ratchet wrench 2 of the second prefer embodiment are as same as the first prefer embodiment, so I will not describe it again.

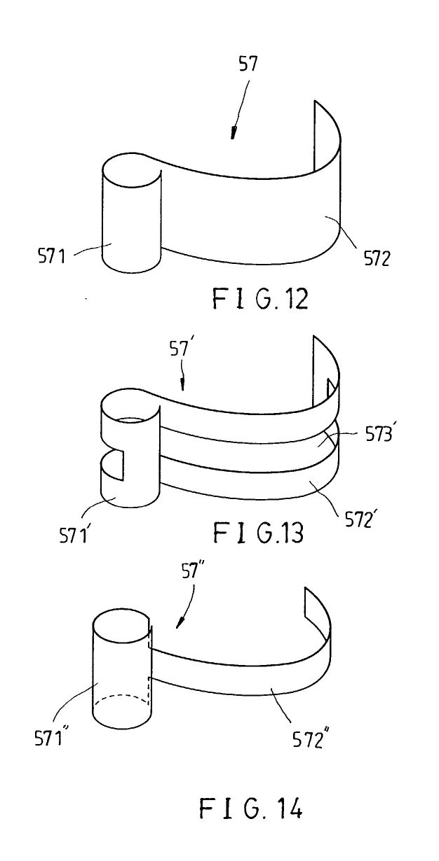

FIG. 13 and FIG. 14 show two alternate self-positioned elastic members 57′ and 57″ of the second prefer embodiment, wherein the self-positioned elastic members 57′ shown in FIG. 13 is made from a flexible piece too to form a positioning portion 571′ and an elastic arm 572′. The piece has an elongated opening 573′ thereon to reduce the material cost and to adjust the elastic capacity of the elastic arm 572′. Another self-positioned elastic member 57″ shown in FIG. 14 is made from a flexible piece too, but it has a strip-liked elastic arm 572″, which means the width of the elastic arm 572″ is smaller than the height of the positioning portion 571″.

What is claimed is:

1. A ratchet wrench, comprising:
a handle having a head portion at an end thereof, a through hole at said head portion and a chamber, wherein said chamber is communicated with said through hole at a side thereof and has a sidewall at the other side thereof;
an engaging member having a polygonal hole at central thereof and an annular teeth portion at exterior surface thereof; said engaging member rotatable installed in said through hole of said handle;
a pawl having a teeth portion at a side thereof; said pawl received in said chamber of said handle at a side thereof, such that said pawl rests against said sidewall in said chamber and said teeth portion thereof is detachable meshed with said teeth portion of said engaging member, and a self-positioned elastic member having a positioning portion and an elastic arm as an unity;
said self-positioned elastic member received in said chamber of said chamber of said handle at the side opposite from said pawl, whereby said positioning portion rests against both of said sidewall of said chamber and said engaging member and said elastic arm has the free end thereof resting against said pawl.

2. The ratchet wrench as defined in claim 1, wherein said self-positioned elastic member is made from a flexible wire for said positioning portion having a spiral shape and said elastic arm projected from an end of said positioning portion.

3. The ratchet wrench as defined in claim 1, wherein said pawl has a slot at a side thereof for receiving the free end of said elastic arm of said self-positioned elastic member therein.

4. The ratchet wrench as defined in claim 3, wherein an included angle between the orientation of said slot of said pawl and the diameter orientation of said engaging member is an acute angle.

5. The ratchet wrench as defined in claim 1, wherein said self-positioned elastic member is made from a flexible piece for said positioning portion having a substantial C-shape in cross-section and said elastic arm projected from said positioning portion.

6. The ratchet wrench as defined in claim 5, wherein said pawl has a gap at a side thereof for receiving the free end of said elastic arm of said self-positioned elastic member therein.

7. The ratchet wrench as defined in claim 5, wherein said flexible piece has an opening.

8. The ratchet wrench as defined in claim 5, wherein the width of said elastic arm is small than the height of said positioning portion.
